(19) United States
(12) Patent Application Publication
(10) Pub. No.: US 2010/0332263 A1
(43) Pub. Date: Dec. 30, 2010

(54) METHOD, APPARATUS AND COMPUTER PROGRAM PRODUCT FOR PROVIDING A CONTRACT COMPLIANCE SOLUTION

(76) Inventors: William Frank, Tolland, CT (US); Lynn Garbee, Weston, CT (US); Jeffrey Springer, Wayne, PA (US)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 12/495,102

(22) Filed: Jun. 30, 2009

(51) Int. Cl. G06Q 40/00; G06F 17/00; G06Q 10/00

(52) U.S. Cl. 705/4; 715/226

(57) ABSTRACT

An apparatus for providing contract compliance may include processing circuitry. The processing circuitry may be configured to receive a contract provision corresponding to a contract defining a responsibility of a payor with respect to payment of a first class of claim, and transform the contract provision, based on rule compliance information defining processing actions to be performed in response to corresponding criteria, into a claim processing rule in a format of a claim adjudication rule associated with a second class of claim. A corresponding method and computer program product are also provided.

### TECHNOLOGICAL FIELD

Embodiments of the present invention relate generally to health care management solutions and, more particularly, relate to a method, apparatus, and computer program product for providing a contract compliance solution.

### BACKGROUND

Healthcare system improvements are continually being developed and sought after by providers and consumers alike. As health systems face economic pressures to increase their bottom line, there are constant efforts to develop measures and management systems that may increase efficiency in various aspects of health care management.

One such aspect relates to the payment of healthcare claims. In this regard, incorrect payment of claims has historically been a major drag on medical loss ratio and administrative expense for many healthcare payors (e.g., insurance companies). A leading driver of incorrect payment is the complexity of the contract terms associated with payment of healthcare claims.

To assist healthcare payors with improving accuracy of claim payment, code editing products have been developed. Code editing products typically include payment rules that comply with American Medical Association (AMA) standards to cover payments related to Medicare, Medicaid, etc. Thus, for example, if a payor receives an office visit and immunization charge, the rules of the code editing product may identify for the payor that the immunization charge is, by rule, supposed to be included in the cost of the office visit. Therefore, the code editing product may identify that the payor should not cover the immunization charge. As illustrated by this example, code editing products are relatively effective in relation to preventing overpayment in relation to professional service claims (e.g., related to visits to doctors' offices). However, code editing products may fall short with respect to facility claims.

Facility claims relate to many different types of medical services that are associated with a particular facility (e.g., outpatient treatment, inpatient treatment, durable medical equipment sales, etc.). Facility claims are typically based on contract terms between the payor and the facility and the terms are often unique from contract to contract. Thus, for different facilities, a payor may have widely varying or customized specific provisions. Contract management systems have been developed independently of the code editing systems described above in order to address facility claims. However, the potential for unique contract terms associated with facility claims has made it difficult to streamline efforts to ensure payment accuracy. Moreover, contact management systems and code editing systems are discrete and distinct systems that may increase expense and complexity by requiring employment of two separate systems

Accordingly, it may be desirable to introduce an improved mechanism for providing payment accuracy.

### BRIEF SUMMARY

A method, apparatus and computer program product are therefore provided to enable the provision of a contract compliance solution that may address some of the problems discussed above. Accordingly, for example, facility and professional claims may be handled by a single contract compliance system in order to provide “total intelligent claim payment”. In this regard, in an exemplary embodiment, a contract compliance solution may be provided that converts terms stipulated in provider contracts into automated rules that can be applied in the adjudication of claims in order to provide payment accuracy checks. Thus, the contract compliance solution of some exemplary embodiments of the claimed invention may provide a linkage between contracting data and the code editing system by converting contracting data (e.g., contract terms associated with the payment of facility claims) into a format that can be extracted and read by the code editing system so that payment rules may be applied to both facility and professional service claims within the same framework.

In one exemplary embodiment, a method of providing a contract compliance solution is provided. The method may include receiving a contract provision corresponding to a contract defining a responsibility of a payor with respect to payment of a first class of claim, and transforming the contract provision, based on rule compliance information defining processing actions to be performed in response to corresponding criteria, into a claim processing rule in a format of a claim adjudication rule associated with a second class of claim.

In another exemplary embodiment, a computer program product for providing a contract compliance solution is provided. The computer program product includes at least one computer-readable storage medium having computer-executable program code instructions stored therein. The computer-executable program code instructions may include program code instructions for receiving a contract provision corresponding to a contract defining a responsibility of a payor with respect to payment of a first class of claim, and transforming the contract provision, based on rule compliance information defining processing actions to be performed in response to corresponding criteria, into a claim processing rule in a format of a claim adjudication rule associated with a second class of claim.

In another exemplary embodiment, an apparatus for providing a contract compliance solution is provided. The apparatus may include processing circuitry. The processing circuitry may be configured to receive a contract provision corresponding to a contract defining a responsibility of a payor with respect to payment of a first class of claim, and transform the contract provision, based on rule compliance information defining processing actions to be performed in response to corresponding criteria, into a claim processing rule in a format of a claim adjudication rule associated with a second class of claim.

### BRIEF DESCRIPTION OF THE SEVERAL VIEWS OF THE DRAWING(S)

Having thus described embodiments of the invention in general terms, reference will now be made to the accompanying drawings, which are not necessarily drawn to scale, and wherein:

FIG. 1 is a diagram illustrating several exemplary operations associated with providing conventional claims processing;

FIG. 2 is a flow diagram illustrating several exemplary operations associated with contract compliance according to an exemplary embodiment of the present invention;

FIG. 3 is a block diagram showing various components that may be included in the contract conversion module 34 according to an exemplary embodiment of the present invention;

FIG. 4 shows an example of an interface that may be provided to a user in connection with a policy editor according to an exemplary embodiment of the present invention;

FIG. 5 shows a policy maintenance screen associated with the policy editor according to an exemplary embodiment of the present invention;

FIG. 6 illustrates an expanded view of a policy window according to an exemplary embodiment of the present invention; and

FIG. 7 is a block diagram according to an exemplary method for providing contract compliance according to an exemplary embodiment of the present invention.

### DETAILED DESCRIPTION

Embodiments of the present invention will now be described more fully hereinafter with reference to the accompanying drawings, in which some, but not all embodiments of the invention are shown. Indeed, embodiments of the invention may be embodied in many different forms and should not be construed as limited to the embodiments set forth herein; rather, these embodiments are provided so that this disclosure will satisfy applicable legal requirements. Like reference numerals refer to like elements throughout.

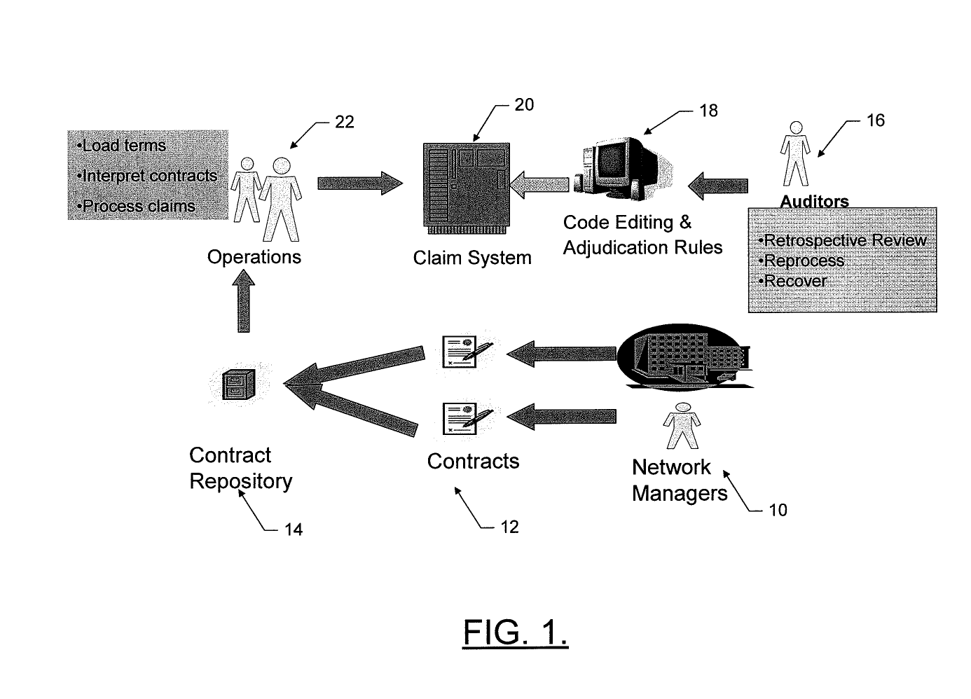

As indicated above, embodiments of the present invention are aimed at providing a mechanism by which contract terms for facility claims may be handled that enables a level of integration of facility claim and professional service claim processing. To better understand embodiments of the present invention, it may be useful to first illustrate one example of a problem being addressed. In this regard, FIG. 1 illustrates a conventional approach to dealing with facility claim and professional service claim processing. In this regard, as shown in FIG. 1, Network managers 10 associated with a payor organization may initially write contracts 12 with various facilities to govern the terms of payment by the payor for various services and/or goods that may be provided by the facilities with which the contracts are entered into. The contracts may then be entered into a contract repository 14 that may store a plurality of contracts, each of which may have many similar and different provisions when compared with other contracts. Thus, the contract repository 14 may include a plurality of contract terms associated with payment provisions for corresponding facilities claims.

Meanwhile, with respect to professional service claims, auditors 16 may initially review rules for adjudicating professional service claims and ensure that the rules (e.g., adjudication rules) are properly reflected in a code editing system 18. Thus, as changes are made to applicable standards that may impact the rules, the auditors 16 may make appropriate changes or edits to enable reprocessing of rules and recovery of adjudication rules. The adjudication rules may then be passed on to a claim system 20. The claim system 20 may receive professional service claims and process the professional service claims according to the adjudication rules.

The claim system 20 may also process facilities claims. However, in order to process facilities claims, the claim system 20 typically requires operations staff 22 to interpret contracts that are associated with a particular claim and load terms in order to enable the claim system 20 to process the facilities claims. Thus, conventional systems such as the system illustrated in FIG. 1 typically require manual application of contract terms retrospectively, which may make the systems not comprehensive, inefficient and potentially prone to errors. However, for reasons provided above, it is not possible to merely automate processing of facilities claims due to the wide variety of contract terms and provisions. Accordingly, a transformation of the conventional approach is needed.

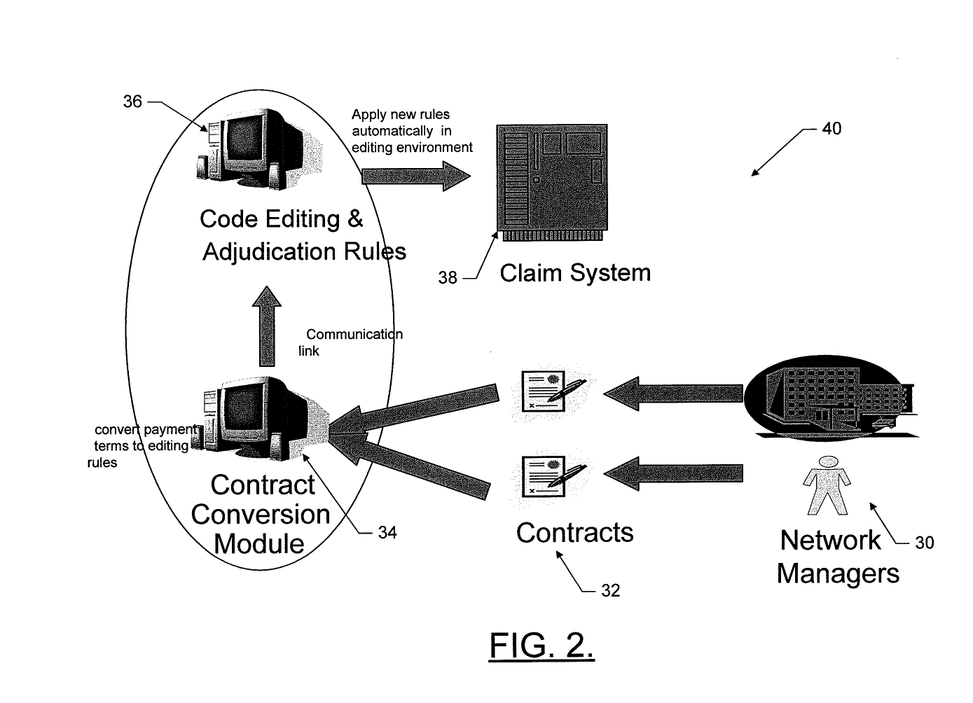

Embodiments of the present invention provide for a transformation of certain aspects of the application of claims editing and processing to enable automatic processing with respect to both facilities claims and professional service claims. In this regard, embodiments of the present invention provide a contract compliance system that includes a contract conversion module for converting contract provisions into standard terms that may be recognized by the code editing system to incorporate facilities claims processing into the adjudication rules that previously governed only professional service claims. FIG. 2 is a diagram illustrating processing data flow according to an exemplary embodiment of the present invention.

As shown in FIG. 2, network managers 30 associated with a payor organization may again initially write contracts 32 with various facilities to govern the terms of payment by the payor for various services and/or goods that may be provided by the facilities with which the contracts entered into. However, instead of transferring the contracts 32 to a contract repository, the contracts 32 may be transferred into a contract conversion module 34 of an exemplary embodiment of the present invention. The contract conversion module 34 may be configured to convert contract provisions into standard terms that may be recognized by a code editing system 36. The code editing system 36, which may be similar to the code editing system of FIG. 1, may be configured to provide adjudication rules to a claim system 38. The claim system 38 may then process facilities and professional service claims using the adjudication rules that, by virtue of conversion of the contract provisions from facilities contracts, enable processing of both facilities and professional service claims. The components of FIG. 2 form a contract compliance system 40 that may substantially reduce or eliminate manual interactions and increase accuracy and consistency with respect to claims processing.

In an exemplary embodiment, the claim system 38, the code editing system 36 and the contract conversion module 34 may each be any means such as a device or circuitry operating in accordance with software or otherwise embodied in hardware or a combination of hardware and software thereby configuring the device or circuitry to perform the corresponding functions of the claim system 38, the code editing system 36 and the contract conversion module 34, respectively, as described herein. Thus, for example, the claim system 38, the code editing system 36 and the contract conversion module 34 could be implemented using computers, servers or other terminals including hardware components capable of executing software defining the operations that cause the corresponding functions of each respective device. As such, in some cases, one or more of the claim system 38, the code editing system 36 and the contract conversion module 34 may be embodied on or in a single computing device. However, in some cases, each of the claim system 38, the code editing system 36 and the contract conversion module 34 may be implemented on separate computing devices that may be in communication with each other over a wired or wireless network.

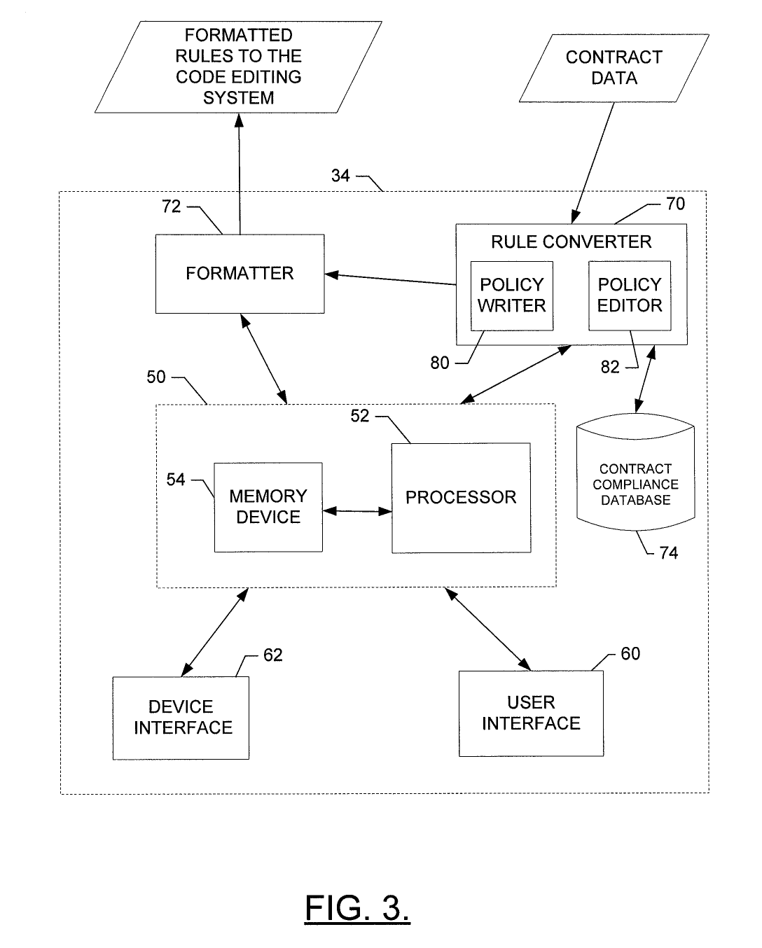

An example embodiment of the contract conversion module 34 will now be described in connection with FIG. 3. In this regard, FIG. 3 is a block diagram showing various components that may be included in the contract conversion module 34 according to an exemplary embodiment. In an exemplary embodiment, the contract conversion module 34 may include processing circuitry 50 that is configured to perform contract provision conversion according to an exemplary embodiment of the present invention. In one embodiment, the processing circuitry 50 may include a processor 52, a storage device 54 that may be in communication with or otherwise control a user interface 60 and a device interface 62. As such, the processing circuitry 50 may be embodied as a circuit chip (e.g., an integrated circuit chip) configured (e.g., with hardware, software or a combination of hardware and software) to perform operations described herein. However, in some embodiments, the processing circuitry 50 may be embodied as a portion of a server, computer, laptop, workstation or even one of various mobile computing devices. In situations where the processing circuitry 50 is embodied as a server or at a remotely located computing device, the user interface 60 may be disposed at another device (e.g., at a computer terminal or client device) that may be in communication with the processing circuitry 50 via the device interface 62 and/or a network.

The user interface 60 may be in communication with the processing circuitry 50 to receive an indication of a user input at the user interface 60 and/or to provide an audible, visual, mechanical or other output to the user. As such, the user interface 60 may include, for example, a keyboard, a mouse, a joystick, a display, a touch screen, a microphone, a speaker, a cell phone, or other input/output mechanisms.

The device interface 62 may include one or more interface mechanisms for enabling communication with other devices and/or networks. In some cases, the device interface 62 may be any means such as a device or circuitry embodied in either hardware, software, or a combination of hardware and software that is configured to receive and/or transmit data from/to a network and/or any other device or module in communication with the processing circuitry 50. In this regard, the device interface 62 may include, for example, an antenna (or multiple antennas) and supporting hardware and/or software for enabling communications with a wireless communication network and/or a communication modem or other hardware/software for supporting communication via cable, digital subscriber line (DSL), universal serial bus (USB), Ethernet or other methods. In situations where the device interface 62 communicates with a network, the network may be any of various examples of wireless or wired communication networks such as, for example, data networks like a Local Area Network (LAN), a Metropolitan Area Network (MAN), and/or a Wide Area Network (WAN), such as the Internet.

In an exemplary embodiment, the storage device 54 may include one or more memory devices such as, for example, volatile and/or non-volatile memory that may be either fixed or removable. The storage device 54 may be configured to store information, data, applications, instructions or the like for enabling the contract conversion module 34 to carry out various functions in accordance with exemplary embodiments of the present invention. For example, the storage device 54 could be configured to buffer input data for processing by the processor 52. Additionally or alternatively, the storage device 54 could be configured to store instructions for execution by the processor 52. As yet another alternative, the storage device 54 may include one of a plurality of databases that may store contract provisions, payment policies or standards, and/or claims adjudication rules.

The processor 52 may be embodied in a number of different ways. For example, the processor 52 may be embodied as various processing means such as a microprocessor or other processing element, a coprocessor, a controller or various other computing or processing devices including integrated circuits such as, for example, an ASIC (application specific integrated circuit), an FPGA (field programmable gate array), a hardware accelerator, or the like. In an exemplary embodiment, the processor 52 may be configured to execute instructions stored in the storage device 54 or otherwise accessible to the processor 52. As such, whether configured by hardware or software methods, or by a combination thereof, the processor 52 may represent an entity (e.g., physically embodied in circuitry) capable of performing operations according to embodiments of the present invention while configured accordingly. Thus, for example, when the processor 52 is embodied as an ASIC, FPGA or the like, the processor 52 may be specifically configured hardware for conducting the operations described herein. Alternatively, as another example, when the processor 52 is embodied as an executor of software instructions, the instructions may specifically configure the processor 52 to perform the operations described herein.

In an exemplary embodiment, the processor 52 (or the processing circuitry 50) may be embodied as, include or otherwise control a rule converter 70 and a formatter 72. The rule converter 70 and the formatter 72 may each be any means such as a device or circuitry operating in accordance with software or otherwise embodied in hardware or a combination of hardware and software (e.g., processor 70 operating under software control, the processor 70 embodied as an ASIC or FPGA specifically configured to perform the operations described herein, or a combination thereof) thereby configuring the device or circuitry to perform the corresponding functions of the rule converter 70 or the formatter 72, respectively, as described below.

The formatter 72 may be configured to take rules generated by the rule converter 70 and put the generated rules into a format that may be useable by the code editing system 36 or another similar system for claims processing. As such, the formatter 72 may be in operable communication with the rule converter 70 in order to operate on the rules generated by the rule converter 70 as described in greater detail below.

The rule converter 70 may be in communication with a contract compliance database 74 that may include payment policies or standards associated with various contracts. Thus, for example, the contract compliance database 74 may define the policies associated with approving/denying payment for specific goods and/or services that may be associated with facilities claims that may be covered by various contracts. As such, the contract compliance database 74 may essentially provide the basis upon which the rule converter 70 transforms contract provisions into a rule. For example, the contract compliance database 74 may include categorizations of types of services, criteria to apply to each categorization with respect to circumstances surrounding a claim that falls into a particular categorization, and a processing action to be taken based on the criteria. Accordingly, as another example, the contract compliance database 74 may define that for category A services provided under circumstance or criteria B, processing action C is to be taken. In this context, as examples, category A may correspond to emergency department care, durable medical goods, inpatient or outpatient care, etc., circumstance B may correspond to a time of day, a time relative to another event, an event status, etc., and processing action C may correspond to denying the claim, paying the claim, etc. In some cases, the contract compliance database 74 may actually be a portion of the storage device 54, while the contract compliance database 74 may be a separate memory device in other cases.

In an exemplary embodiment, the rule converter 70 may be configured to receive, retrieve, or otherwise access information from the contract compliance database 74 regarding payment policies and/or standards regarding payment of claims. The rule converter 70 may then act as a rule conversion engine configured to convert the contract provisions associated with contract data received for contracts that are desired to be converted into corresponding rule logic defining the conditions under which payment is authorized or not authorized for specific claims based on the payment policies or standards from the contract compliance database 74. Thus, after the contract compliance database 74 is robustly populated with information, most if not all contract provisions may be automatically converted into rules that may be handled by the code editing system 36 to enable automatic claim processing for both facilities claims and professional service claims by the claim system 38.

In an exemplary embodiment, the rule converter 70 may further include one or more interfaces that may enable an operator or user to interface with the rule converter 70 to provide data and/or instructions to the rule converter. In this regard, in some cases, the rule converter 70 may include or otherwise be in communication with a policy writer 80 and a policy editor 82 each of which may be any means such as a device or circuitry operating in accordance with software or otherwise embodied in hardware or a combination of hardware and software thereby configuring the device or circuitry to perform the corresponding functions of the policy writer 80 or the policy editor 82, respectively, as described below. In an exemplary embodiment, the policy writer 80 and the policy editor 82 may each be executable software modules comprising instructions for enabling the respective functionalities described below.

The policy writer 80 may be configured to enable entry of words or text into corresponding data fields defining portions of a contract or contract provisions in a manner that is usable by the rule converter 70 (e.g., via the policy editor 82). Thus, for example, the policy writer 80 may receive text strings that may be parsed for key or recognizable words, formats or codes that may correspond to data fields having known or standard parameters or meanings associated therewith. For example, the policy writer 80 may be configured to recognize, e.g., from within contracts, information defining periods of time during which or locations at which certain provisions apply. Thus, for example, time periods where certain payment criteria are applicable (e.g., a field for emergency department visit coverage periods) may be defined in fields. In an exemplary embodiment, fields may be created to correspond to each stipulation or each primary element within various contract provisions such that a given contract may be broken down into applicable provisions as represented by data fields that correspond to the applicable provisions for the given contract. Thus, in an exemplary embodiment, the policy writer 80 may be a module equipped to enable conversion of each of a plurality of different contracts with one or more facilities into a set of standardized data entries (e.g., defined in various standard fields) corresponding to the provisions of each respective contract so that each contract is processed into an electronic format by providing a user definable conversion template.

While the written contracts are converted into an electronic form by the policy writer 80, the policy editor 82 may provide users with an ability to populate information in the contract compliance database 74. In other words, the policy editor 82 may enable the user to provide the basis upon which the rule converter 70 will perform rule conversions to correlate the data fields of contract provisions with corresponding rules based on the payment policies. Thus, the policy editor 82 may essentially enable completion of the conversion of a written contract into a set of applicable rules that may be recognized by the code editing system 36 for rule adjudication by the claim system 38 of FIG. 2. In this regard, for example, the policy editor 82 may be configured to enable the user to define criteria used to convert policy terms (provided in electronic format by the policy writer 80) into a structured rule statement. In an exemplary embodiment, the structured rule statement may be provided in a particular format such as RML (relational markup language). In some cases, the policy editor 82 may itself be configured to output rules in the particular format. However, regardless of the format of the rules generated by the rule converter 70, the formatter 72 may be configured to translate or otherwise convert the rules into a format that is usable by downstream components or systems. In an exemplary embodiment, a downstream component may be a Claims Xten Payment Platform (CXT) that may be an example of a code editing system (e.g., code editing system 36) with which embodiments of the present invention may operate.

In an exemplary embodiment, the policy editor 82 may be further configured to push formatted rules (e.g., in a format acceptable to the code editing system 36 via the formatter 72) to the code editing system 36. Thus, for example, a rule created or modified by the policy editor 82 may be activated (e.g., via a user interface selectable option) after conversion of the rule into the proper format by sending the rule to the code editing system 36. Furthermore, in some embodiments, the policy editor 82 may provide user interface options such as a selection mechanism to enable an operator or user to define which rules are associated with a particular provider or payor. In other words, payor-specific rules may be implemented using the policy editor 82 in some cases. In another exemplary embodiment, the policy editor 82 may be configured to enable the establishment of a rule hierarchy. Thus, for example, an ordering or priority (perhaps also specific to each respective payor) may be applied to certain rules.

In some cases, the code editing system 36 may be modified from a conventional code editing system to accept policy rules from the formatter 72 or the rule converter 70. In an exemplary embodiment, due to the formatter 72 having placed the rules generated by the rule converter 70 into a format usable by the code editing system 36, the code editing system 36 may be enabled to apply substantially the same code editing processes used for professional service claims to facilities claim based rules provided by the rule converter 70. Thus, for example, the formatter 72 or the rule converter 70 may be configured to support the modes in which the code editing system 36 may operate.

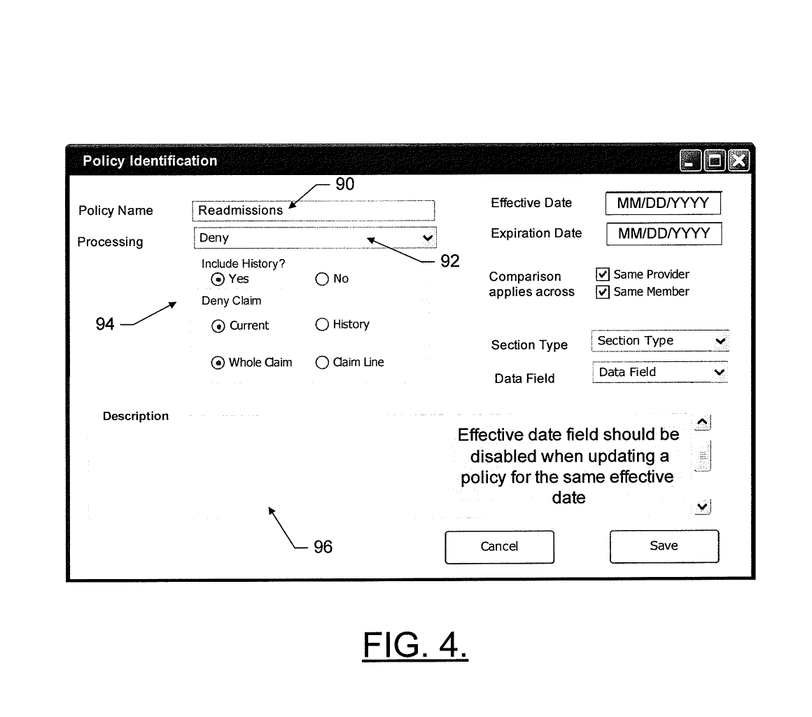

FIGS. 4-6 are screen shots illustrating examples of interface mechanisms that may be provided in accordance with an exemplary embodiment. The screenshots may be generated by the processing circuitry 50 and displayed at a display of the user interface 60. FIG. 4 shows an example of an interface that may be provided to a user in connection with the policy editor 82. In this regard, FIG. 4 shows a policy identification screen in which a specific contract provision related to policy regarding readmissions may be processed to enable converting a contract to electronic form. The policy identification screen may include a field 90 for a name for the corresponding policy and a field 92 identifying the processing action (e.g., deny, process for payment, etc.) to be taken. Options 94 may then be presented with respect to the processing action for inclusion of claim history information such that processing may be taken with respect to a current claim or a claim history. Furthermore, a whole claim may be processed (e.g., denied or approved) or just a particular claim line may be processed according to the processing action defined. General description data may be provided in a description field 96 and effective and expiration dates may also be defined. In some cases, further information enabling comparison of the current rule across the same provider or the same member may also be provided.

Accordingly, the policy editor 82 may act as a facility editing sub-module used to define the policies required for facility claim editing. Each policy may be associated with a data field. However, a particular data field may be associated with multiple policies. Data fields may then provide an association between the policies and the contracts or template sections with which they correspond.

Policies may undergo a workflow process as template objects. As such, a policy (e.g., comprising one or more contract provisions) may initially have a draft status, which may later change to in-review, approved, not approved, live, expired, etc., dependent upon actions taken by owners or reviewers and/or the passage of time. Draft policies may be subject to editing, but in some cases live policies may require that a draft version be created in order to permit editing. In some embodiments, if a new version of a policy is made live, older versions may expire. However, separate versions of a policy may be provided with different effective dates.

The policy editor 82 may include multiple screens such as, for example, a policy maintenance screen, a policy search screen, and others. The search screen may be used to search policies by policy name, data name, codes used to define policy criteria and/or the like. Partial name searching may also be provided. New policies may be created from scratch or copied and modified from existing policies. Review of policies may then be accomplished via a task screen or some other mechanism.

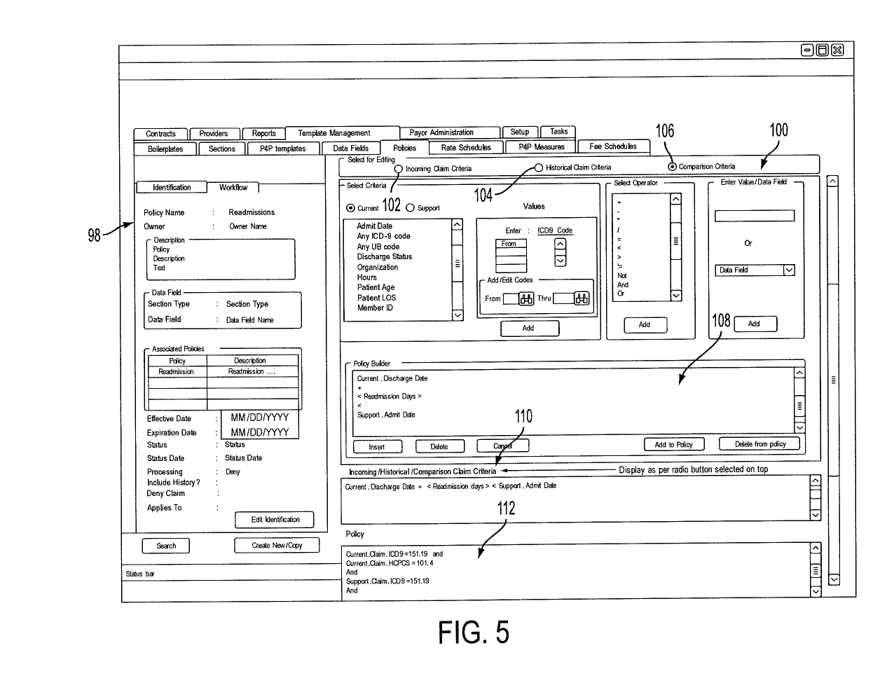

FIG. 5 shows a policy maintenance screen associated with the policy editor 82 according to an exemplary embodiment. The policy maintenance screen may be displayed after a policy is selected from the search screen or after a policy creation or edit operation is selected. In some cases, the policy maintenance screen may include a section 98 providing information from the policy identification screen along with a window that may have a selected one of a plurality of possible options displayed. In this regard, the policy maintenance screen may include at least three general sections that may be displayed in a main window 100 in response to selection of a corresponding section selector (e.g., an incoming claim criteria section selector 102, a historical/support claim criteria section selector 104 and a comparison criteria section selector 106. In an exemplary embodiment, if the incoming claim criteria section selector 102 is selected, the criteria for selection may only apply to incoming claims and thus selection criteria may apply to “current” options. If the historical/support claim criteria section selector 104 is selected, the selection criteria may apply to “support” options. If the comparison criteria section selector 106 is selected, either “current” or “support” options may be selected from.

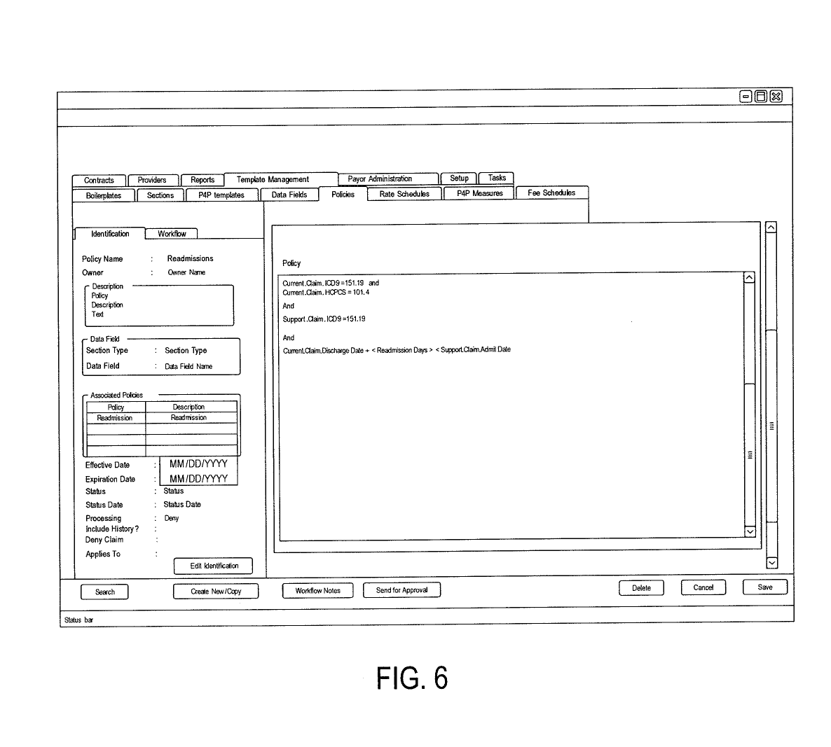

A policy builder section 108 may be used to modify particular lines of a policy and window 110 will be labeled based on the general section selected. By selecting selection criteria and corresponding values or operators for editing a policy, the policy may be added or edited. By clicking “add to policy” button, the corresponding criteria may be moved from the policy builder section 108 to the window 110. The complete policy may be displayed in a policy window 112. In some cases, each window displayed may include a scroll bar to enable viewing of portions that may be compressed to allow more than one window to fit on the screen at any given time. FIG. 6 illustrates an expanded view of the policy window 112 according to an exemplary embodiment.

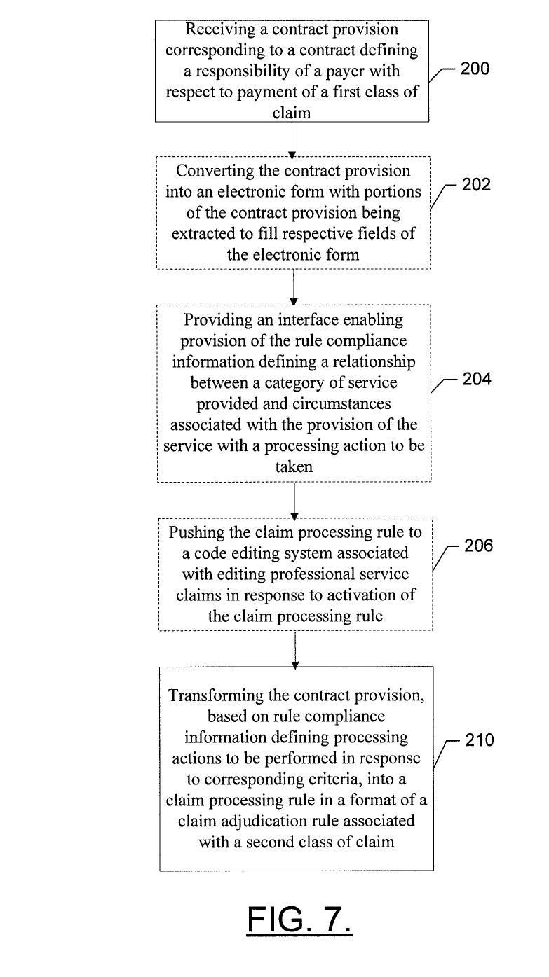

Embodiments of the present invention may be practiced using an apparatus such as the one depicted in FIG. 3. However, other embodiments may be practiced in connection with a computer program product for performing embodiments of the present invention. FIG. 7 is a flowchart of a method and program product according to exemplary embodiments of the invention. Each block or step of the flowchart of FIG. 7, and combinations of blocks in the flowchart, may be implemented by various means, such as hardware, firmware, processor, circuitry and/or another device associated with execution of software including one or more computer program instructions. Thus, for example, one or more of the procedures described above may be embodied by computer program instructions, which may embody the procedures described above and may be stored by a storage device (e.g., storage device 52) and executed by processing circuitry (e.g., processor 54).

As will be appreciated, any such stored computer program instructions may be loaded onto a computer or other programmable apparatus (i.e., hardware) to produce a machine, such that the instructions which execute on the computer or other programmable apparatus implement the functions specified in the flowchart block(s) or step(s). These computer program instructions may also be stored in a computer-readable medium comprising memory that may direct a computer or other programmable apparatus to function in a particular manner, such that the instructions stored in the computer-readable memory produce an article of manufacture including instructions to implement the function specified in the flowchart block(s) or step(s). The computer program instructions may also be loaded onto a computer or other programmable apparatus to cause a series of operational steps to be performed on the computer or other programmable apparatus to produce a computer-implemented process such that the instructions which execute on the computer or other programmable apparatus provide steps for implementing the functions specified in the flowchart block(s) or step(s).

In this regard, a method according to one embodiment of the invention, as shown in FIG. 7, may include receiving a contract provision corresponding to a contract defining a responsibility of a payor with respect to payment of a first class of claim at operation 200 and transforming the contract provision, based on rule compliance information defining processing actions to be performed in response to corresponding criteria, into a claim processing rule in a format of a claim adjudication rule associated with a second class of claim at operation 210.

In some embodiments, certain ones of the operations above may be modified or further amplified as described below. It should be appreciated that each of the modifications or amplifications below may be included with the operations above either alone or in combination with any others among the features described herein. In this regard, for example, receiving the contract provision may include receiving the contract provision corresponding to the first class of claim comprising a facilities claim, and transforming the contract provision may include transforming the contract provision into the claim processing rule in the format of the claim adjudication rule associated with a professional services claim. Additionally or alternatively, transforming the contract provision may include formatting the claim processing rule generated in a relational markup language into the format of the claim adjudication rule comprising a proprietary format.

In some embodiments, the method may further include other optional operations, examples of which are shown in dashed lines in FIG. 7. In this regard, for example, in some cases the method may further include converting the contract provision into an electronic form with portions of the contract provision being extracted to fill respective fields of the electronic form at operation 202 and/or providing an interface enabling provision of the rule compliance information defining a relationship between a category of service provided and circumstances associated with the provision of the service with a processing action to be taken at operation 204. In some cases, the method may include pushing the claim processing rule to a code editing system associated with editing professional service claims in response to activation of the claim processing rule at operation 206.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. An apparatus comprising processing circuitry configured to at least perform the following:
receiving a contract provision corresponding to a contract defining a responsibility of a payor with respect to payment of a first class of claim; and
transforming the contract provision, based on rule compliance information defining processing actions to be performed in response to corresponding criteria, into a claim processing rule in a format of a claim adjudication rule associated with a second class of claim.

2. The apparatus of claim 1, wherein the processing circuitry is further configured to convert the contract provision into an electronic form with portions of the contract provision being extracted to fill respective fields of the electronic form.

3. The apparatus of claim 1, wherein the processing circuitry being configured to receive the contract provision comprises receiving information with respect to payment of the first class of claim corresponding to a facilities claim, and
wherein the processor being configured to transform the contract provision comprises transforming the contract provision into the claim processing rule in the format associated with the second class of claim corresponding to a professional services claim.

4. The apparatus of claim 1, wherein the processing circuitry is further configured to provide an interface enabling provision of the rule compliance information defining a relationship between a category of service provided and circumstances associated with the provision of the service with a processing action to be taken.

5. The apparatus of claim 1, wherein the apparatus further comprises a formatter configured to convert the claim processing rule into the format of the claim adjudication rule.

6. The apparatus of claim 5, wherein the formatter is configured to convert the claim processing rule generated in a relational markup language into the format of the claim adjudication rule comprising a proprietary format.

7. The apparatus of claim 1, wherein the processing circuitry is further configured to push the claim processing rule to a code editing system associated with editing professional service claims in response to activation of the claim processing rule.

8. A method comprising:
receiving a contract provision corresponding to a contract defining a responsibility of a payor with respect to payment of a first class of claim; and
transforming the contract provision, based on rule compliance information defining processing actions to be performed in response to corresponding criteria, into a claim processing rule in a format of a claim adjudication rule associated with a second class of claim.

9. The method of claim 8, further comprising converting the contract provision into an electronic form with portions of the contract provision being extracted to fill respective fields of the electronic form.

10. The method of claim 8, wherein receiving the contract provision comprises receiving the contract provision corresponding to the first class of claim comprising a facilities claim; and
wherein transforming the contract provision comprises transforming the contract provision into the claim processing rule in the format of the claim adjudication rule associated with a professional services claim.

11. The method of claim 8, further comprising providing an interface enabling provision of the rule compliance information defining a relationship between a category of service provided and circumstances associated with the provision of the service with a processing action to be taken.

12. The method of claim 8, further comprising pushing the claim processing rule to a code editing system associated with editing professional service claims in response to activation of the claim processing rule.

13. The method of claim 8, wherein transforming the contract provision comprises formatting the claim processing rule generated in a relational markup language into the format of the claim adjudication rule comprising a proprietary format.

14. A computer program product comprising at least one computer-readable storage medium having computer-executable program code instructions stored therein, the computer-executable program code instruction comprising:
program code instructions for receiving a contract provision corresponding to a contract defining a responsibility of a payor with respect to payment of a first class of claim; and
program code instructions for transforming the contract provision, based on rule compliance information defining processing actions to be performed in response to corresponding criteria, into a claim processing rule in a format of a claim adjudication rule associated with a second class of claim.

15. The computer program product of claim 14, further comprising program code instructions for converting the contract provision into an electronic form with portions of the contract provision being extracted to fill respective fields of the electronic form.

16. The computer program product of claim 14, wherein program code instructions for receiving the contract provision includes instructions for receiving the contract provision corresponding to the first class of claim comprising a facilities claim; and
wherein program code instructions for transforming the contract provision include instructions for transforming the contract provision into the claim processing rule in the format of the claim adjudication rule associated with a professional services claim.

17. The computer program product of claim 14, further comprising program code instructions for providing an interface enabling provision of the rule compliance information defining a relationship between a category of service provided and circumstances associated with the provision of the service with a processing action to be taken.

18. The computer program product of claim 14, further comprising program code instructions for pushing the claim processing rule to a code editing system associated with editing professional service claims in response to activation of the claim processing rule.

19. The computer program product of claim 14, further comprising program code instructions for defining a formatter configured to convert the claim processing rule into the format of the claim adjudication rule.

20. The computer program product of claim 19, wherein the program code instructions for defining the formatter include instructions for configuring the formatter to convert the claim processing rule generated in a relational markup language into the format of the claim adjudication rule comprising a proprietary format.
